(19) United States
(12) Patent Application Publication
(10) Pub. No.: US 2016/0028716 A1
(43) Pub. Date: Jan. 28, 2016

(54) ROUTING PROTOCOL AUTHENTICATION MIGRATION

(71) Applicant: HANGZHOU H3C TECHNOLOGIES CO., LTD., Hangzhou, Zhejiang (CN)

(72) Inventor: Changwang LIN, Beijing (CN)

(73) Assignee: Hangzhou H3C Technologies Co., Ltd., Hangzhou City (CN)

(21) Appl. No.: 14/769,020

(22) PCT Filed: Mar. 12, 2014
(86) PCT No.: PCT/CN2014/073278

§ 371 Date: Aug. 19, 2015

(30) Foreign Application Priority Data
Apr. 16, 2013 (CN) 201310132266.7

(51) Int. Cl. H04L 29/06

(52) U.S. Cl. CPC H04L 63/083; H04L 63/166

(57) ABSTRACT

A first migration instruction is received from a management device, new authentication information is configured on a routing device according to the first migration instruction, and an authentication direction of the new authentication information is configured as a receiving direction. A second migration instruction that is sent by the management device after determining that all adjacent routing devices have configured the new authentication information is received, an authentication direction of original active authentication information is configured as a receiving direction and the authentication direction of the new authentication information is configured as the receiving direction and a sending direction.

### BACKGROUND

In view of safety, authentication is usually configured in a routing protocol. The routing protocol authentication may include a simple authentication mode and an encryption authentication mode. Commonly used encryption authentication algorithms include hmac-md5 (Hash-based message authentication code message-digest algorithm 5), hmac-sha (secure hash algorithm) 1-12, hmac-sha1-20-md5, sha-1, etc.

In actual applications, an authentication mode (also called an authentication algorithm) and an authentication password of routing protocol authentication may be modified, which relates to routing protocol authentication migration. Taking Open Shortest Path First (OSPF) protocol for instance, the routing protocol authentication migration is described hereinafter.

### BRIEF DESCRIPTION OF THE DRAWINGS

Features of the present disclosure are illustrated by way of example and not limited in the following figure(s), in which like numerals indicate like elements, in which:

FIG. 1 is a flowchart illustrating a method for implementing routing protocol authentication migration according to an example of the present disclosure.

FIG. 2 is a diagram illustrating a network for implementing routing protocol authentication migration according to an example of the present disclosure.

FIG. 3 is a diagram illustrating the structure of a device for implementing routing protocol authentication migration according to an example of the present disclosure.

FIG. 4 is a diagram illustrating the hardware structure of a routing device to which the method and device for implementing routing protocol authentication migration may be applied according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

Suppose MD5 authentication mode is used in the OSPF protocol, a process for implementing OSPF routing protocol authentication migration may be described as follows.

In a normal operation, a routing device sends a protocol packet through an interface running the OSPF protocol in which the MD5 authentication mode is used. The protocol packet contains an active authentication password. The active authentication password is the latest MD5 authentication password.

When the active authentication password is to be modified, the routing device may configure a new MD5 authentication password first, and then trigger an MD5 authentication migration process. In the MD5 authentication migration process, the routing device may send a protocol packet containing the MD5 authentication password. When receiving protocol packets from all adjacent routing devices, the routing device may authenticate the protocol packets respectively with authentication information configured locally. As long as one piece of authentication information is passed successfully, the protocol packets pass the authentication successfully.

When the routing device receives protocol packets containing the new MD5 authentication password respectively from all adjacent routing devices, the MD5 authentication migration process terminates. At this case, the normal operation of the routing device is restored, and the new MD5 authentication password becomes an active authentication password.

In the above MD5 authentication migration process, multiple protocol packets need to be sent. Accordingly, large number of protocol packets is generated in an instant, thereby affecting processing performance of devices.

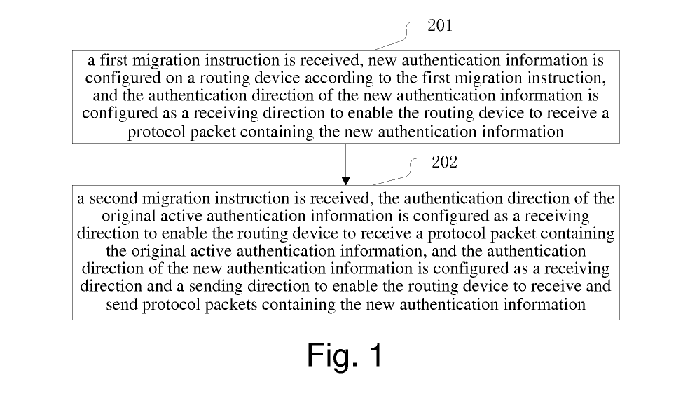

FIG. 1 is a flowchart illustrating a method for implementing routing protocol authentication migration according to an example of the present disclosure. The method includes following blocks.

At block 201, a first migration instruction is received, new authentication information is configured on a routing device according to the first migration instruction, and the authentication direction of the new authentication information is configured as a receiving direction to enable the routing device to receive a protocol packet containing the new authentication information.

The new authentication information includes a new authentication mode and a new authentication password.

In an example, the first migration instruction may be sent to all adjacent routing devices by a management device to make all adjacent routing devices enter the first phase of authentication migration.

After a routing device receives the first migration instruction and configures the new authentication information locally according to the first migration instruction, the routing device sends a configuration success confirming packet to the management device. According to the configuration success confirming packet, the management device may determine that the routing device has configured the new authentication information successfully.

After the authentication direction of the new authentication information is configured as the receiving direction, the routing device may receive a protocol packet containing the new authentication information. Since the authentication direction of original active authentication information still includes a sending direction and a receiving direction, an authentication password contained in a protocol packet sent by the routing device is still an original active authentication password of the original active authentication information. The original active authentication information includes an original active authentication mode and the original active authentication password.

At block 202, a second migration instruction is received, the authentication direction of the original active authentication information is configured as a receiving direction to enable the routing device to receive a protocol packet containing the original active authentication information, and the authentication direction of the new authentication information is configured as a receiving direction and a sending direction to enable the routing device to receive and send protocol packets containing the new authentication information.

In actual applications, the protocol packet containing the new authentication information cannot pass the authentication of the routing device unless the routing device has configured the new authentication information. In order to ensure that a protocol packet is not lost when the original active authentication information is changed into the new authentication information, all adjacent routing devices should configure the new authentication information first, and then enter the second phase of authentication migration. In the second phase of authentication migration, the original active authentication information has been changed into the new authentication information, and the routing device may send a protocol packet containing the new authentication information.

In an example, the management device may make all adjacent routing device enter the second phase of authentication migration after confirming that all adjacent routing devices have configured the new authentication information.

The management device may confirm, through following two methods, that all adjacent routing devices have configured the new authentication information.

In a first method, if the management device receives configuration success confirming packets from all adjacent routing devices after sending the first migration instruction to all adjacent routing devices, the management device may confirm that all adjacent routing devices have configured the new authentication information.

In a second method, the management device starts a timer after sending the first migration instruction to all adjacent routing devices. The period of the timer should meet a condition, that is, all adjacent routing devices can receive the first migration instruction and configure the new authentication information successfully according to the first migration instruction during the period. When the timer expires, the management device may confirm that all adjacent routing devices have configured the new authentication information.

In an example, after confirming that all adjacent routing devices have configured the new authentication information, the management device may send the second migration instruction to all adjacent routing devices to make the routing device enter the second phase of authentication migration according to the second migration instruction.

After receiving the second migration instruction from the management device, the routing device enters the second phase of authentication migration. In the second phase of authentication migration, the routing device has changed the original active authentication information into the new authentication information, and thus a protocol packet sent by the routing device contains the new authentication information instead of the original active authentication information. Accordingly, the authentication direction of the new authentication information should be configured as the receiving direction and the sending direction, so that the routing device may send and receive protocol packets containing the new authentication information. Furthermore, the authentication direction of the original active authentication information should be configured as the receiving direction, so that the routing device may still receive a protocol packet containing the original active authentication information, but cannot send a protocol packet containing the original active authentication information any more. After entering the second phase of authentication migration, the original active authentication information contained in the protocol packet sent by the routing device has been changed into the new authentication information.

After enabling the routing device to receive the protocol packet containing the new authentication information, if the routing device receives protocol packets containing the new authentication information from all adjacent routing devices, the authentication migration terminates.

After entering the second phase of authentication migration, the routing device sends a protocol packet containing the new authentication information to an adjacent routing device, and receives a protocol packet containing the new authentication information from the adjacent routing device. When receiving protocol packets containing the new authentication information from all adjacent routing devices, the routing device may determine that the authentication migration terminates. However, since some network factors such as a network failure may make the routing device unable to receive the protocol packets containing the new authentication information from all adjacent routing devices timely, the authentication migration should be forced to terminate. Therefore, when configuring the authentication direction of the new authentication information as the receiving direction and the sending direction, the routing device may start a smooth migration timer. If the routing device does not receive the protocol packets containing the new authentication information from all adjacent routing devices until the smooth migration timer expires, the authentication migration may terminate.

After the authentication migration terminates, the routing device may delete the original active authentication information, thereby avoiding the waste of storage resources.

In the example shown in FIG. 1, when the authentication migration is performed, the new authentication information may be contained in the first migration instruction. When receiving the first migration instruction from the management device, the routing device may configure the authentication information contained in the first migration instruction locally as the new authentication information. In actual applications, an authentication information list may be pre-stored in the routing device. The authentication information list includes the new authentication information. The management device may send the first migration instruction containing an authentication information identity to the routing device. When receiving the first migration instruction from the management device, the routing device may search the pre-stored authentication information list for authentication information corresponding to the authentication information identity contained in the first migration instruction, and configure the searched-out authentication information locally as the new authentication information. In this disclose the term “searched out” means the information or item found as a result of the searching. For instance, in the example above, the ‘searched out authentication information’ is authentication information in the authentication information list which is identified as corresponding to the authentication information identity contained in the first migration instruction. When information is ‘not searched out’, that means that no information matching the search criteria was found.

A method for configuring the authentication direction of authentication information may include configuring the authentication direction of authentication password of the authentication information

In actual applications, the protocol authentication may include interface-based protocol authentication, Transmission Control Protocol (TCP)-based protocol authentication, device-based protocol authentication and domain-based protocol authentication.

When the interface-based protocol authentication is adopted, the all adjacent routing devices may be all adjacent routing devices of the routing device that are connected to the interface. Routing Information Protocol (RIP), Bidirectional Forwarding Detection (BFD) protocol, OSPF protocol and Intermediate System-to-Intermediate System (IS-IS) protocol may support the interface-based protocol authentication.

When the TCP-based protocol authentication is adopted, the all adjacent routing devices are opposite adjacent routing devices associated with the routing device through a TCP connection. Border Gateway Protocol (BGP) may support the TCP-based protocol authentication.

When the device-based protocol authentication is adopted, the all adjacent routing devices are all routing devices connected to the routing device. The RIP, the BFD protocol, the OSPF protocol, the IS-IS protocol and the BGP may support the device-based protocol authentication.

When the domain-based protocol authentication is adopted, the all adjacent routing devices are all routing devices located in the same domain as the routing device. The OSPF protocol and the IS-IS protocol may support the domain-based protocol authentication.

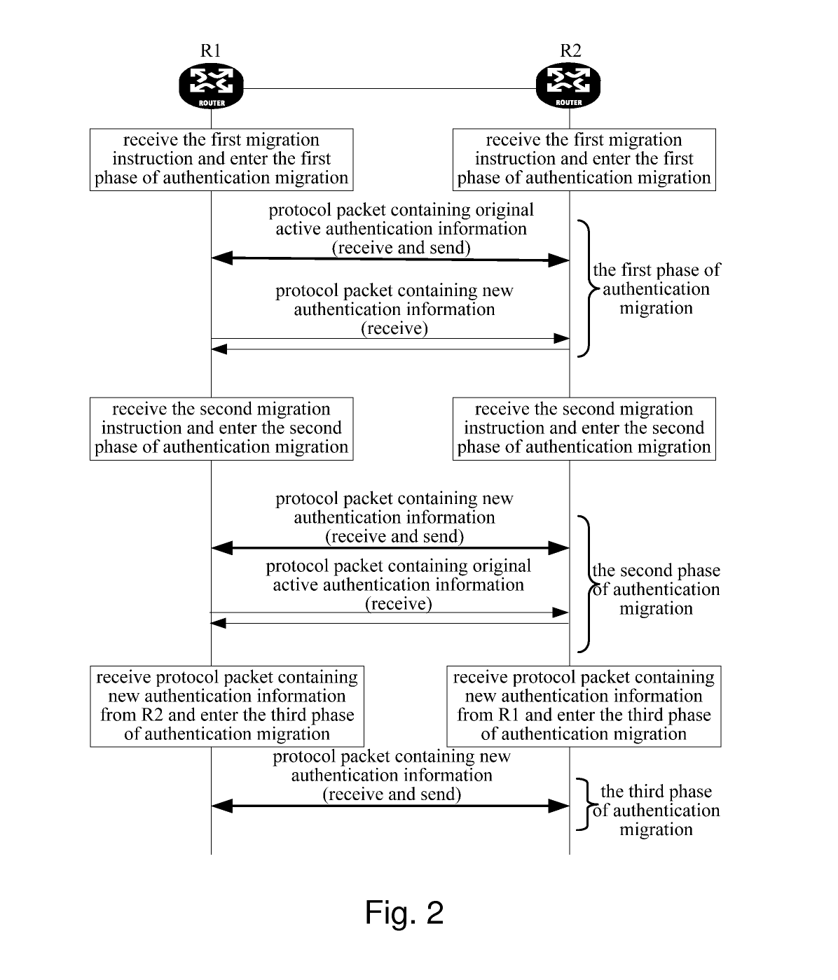

The method for implementing routing protocol authentication migration shown in FIG. 1 is described with reference to FIG. 2.

FIG. 2 is a diagram illustrating a network for implementing routing protocol authentication migration according to an example of the present disclosure. As shown in FIG. 2, routing device R1 is connected to routing device R2. Suppose routing devices in the network all adopt the interface-based protocol authentication. In an initial state, the routing device R1 and the routing device R2 both adopt a simple plain-text authentication mode and an authentication password is 123.

When the authentication migration does not occurs, protocol packets sent to respective opposite devices by the R1 and the R2 contain current active authentication information. That is, the simple plain-text authentication mode is adopted and the authentication password is 123. The R1 and the R2 also receive protocol packets containing the current active authentication information from respective opposite devices, and authenticate the received protocol packets respectively with the locally configured authentication password “123”. After the authentication is passed successfully, the protocol packets are processed normally.

When the authentication modes of R1 and R2 are to be changed into an MD5 encryption authentication mode from the plain-text authentication mode, the authentication migration includes three phases. When the MD5 encryption authentication mode is adopted, a new authentication password is abc.

In the first phase, new authentication information is configured on each routing device. The new authentication information includes a new authentication mode “MD5 encryption authentication mode” and a new authentication password “abc”. The authentication direction of the new authentication information is configured to make the routing device receive a protocol packet containing the new authentication information.

The first phase is triggered by the management device. The management device sends the first migration instruction to each routing device, so that each routing device may configure the new authentication information according to the first migration instruction.

Referring to FIG. 2, the process of configuring the new authentication information on the routing device is implemented as follows. After receiving the first migration instruction from the management device, the R1 and the R2 respectively configure the new authentication information. The new authentication mode is the MD5 encryption authentication mode and the new authentication password is abc. After configuring the new authentication information, the R1 and the R2 respectively configure the authentication direction of the new authentication information as the receiving direction, and then enter the first phase of the authentication migration. In the first phase of the authentication migration, the R1 and the R2 may both receive protocol packets containing the new authentication information and protocol packets containing the original active authentication information. In the original active authentication information, the simple plain-text authentication mode is adopted, and the authentication password is 123. The protocol packets sent by the R1 and the R2 contain the original active authentication information respectively.

In the second phase, the authentication direction of the original active authentication information and the authentication direction of the new authentication information are preconfigured respectively, so that the R1 and the R2 may send protocol packets containing the new authentication information and may receive protocol packets containing the new authentication information and protocol packets containing the original active authentication information.

The second phase is triggered by the management device. The management device may send the second migration instruction to each routing device, so that each routing device may preconfigure the authentication direction of the new authentication information and the authentication direction of the original active authentication information.

Referring to FIG. 2, after receiving the second migration instruction from the management device, the R1 and the R2 both preconfigure the authentication direction of the new authentication information and the authentication direction of the original active authentication information. In the new authentication information, the authentication mode is the MD5 encryption authentication mode and the authentication password is abc. In the original active authentication information, the authentication mode is the simple plain-text authentication mode and the authentication password is 123. The process of preconfiguring the authentication direction of the new authentication information and the authentication direction of the original active authentication information is implemented as follows. The R1 and the R2 respectively modify local configuration, configure the authentication direction of the new authentication information as the receiving direction and the sending direction, start a smooth migration timer, configure the authentication direction of the original active authentication information as the receiving direction, and then enter the second phase of authentication migration. In the second phase of authentication migration, protocol packets sent by the R1 and the R2 all contain the new authentication information. Further, the R1 and the R2 may both receive protocol packets containing the new authentication information and protocol packets containing the original active authentication information.

In the third phase, the authentication migration terminates, and the R1 and the R2 delete the original active authentication information respectively, and receive and send protocol packets containing the new authentication information.

The third phase begins when the routing device determines that the authentication migration terminates. When the routing device receives protocol packets containing the new authentication information that are sent by all adjacent routing devices, or after the smooth migration timer expires, the routing device may determine that the authentication migration terminates.

Referring to FIG. 2, after the R1 receives a protocol packet containing the new authentication information from the R2, the R1 determines that subsequent packets sent by the R2 all contain the new authentication information. In the new authentication information, the authentication mode is the MD5 encryption authentication mode and the authentication password is abc. Since the R1 has one adjacent routing device R2 on an interface connected to the R2, the R1 determines that the authentication migration terminates and deletes the original active authentication information. Afterwards, the R1 may send and receive protocol packets adopting the MD5 encryption authentication mode and the authentication password “abc”, but cannot receive a protocol packet adopting another authentication mode. After the R2 receives a protocol packet containing the new authentication information from the R1, the R2 determines that subsequent packets sent by the R1 all contain the new authentication information. Since the R2 has one adjacent routing device R1 on an interface connected to the R1, the R2 determines that the authentication migration terminates and deletes the original active authentication information. Afterwards, the R2 may send and receive protocol packets adopting the MD5 encryption authentication mode and the authentication password “abc”, but cannot receive a protocol packet adopting another authentication mode.

In the three phases of authentication migration, the routing device may send protocol packets with one authentication password. In the first phase, the authentication password in the original active authentication information is adopted, and in the second and third phases, the authentication password in the new authentication information is adopted. Compared with a solution in which protocol packets are sent with multiple authentication passwords, this solution may avoid a case that multiple protocol packets containing different authentication passwords are sent at the same time, thereby reducing the number of sent protocol packets and improving processing performance of device.

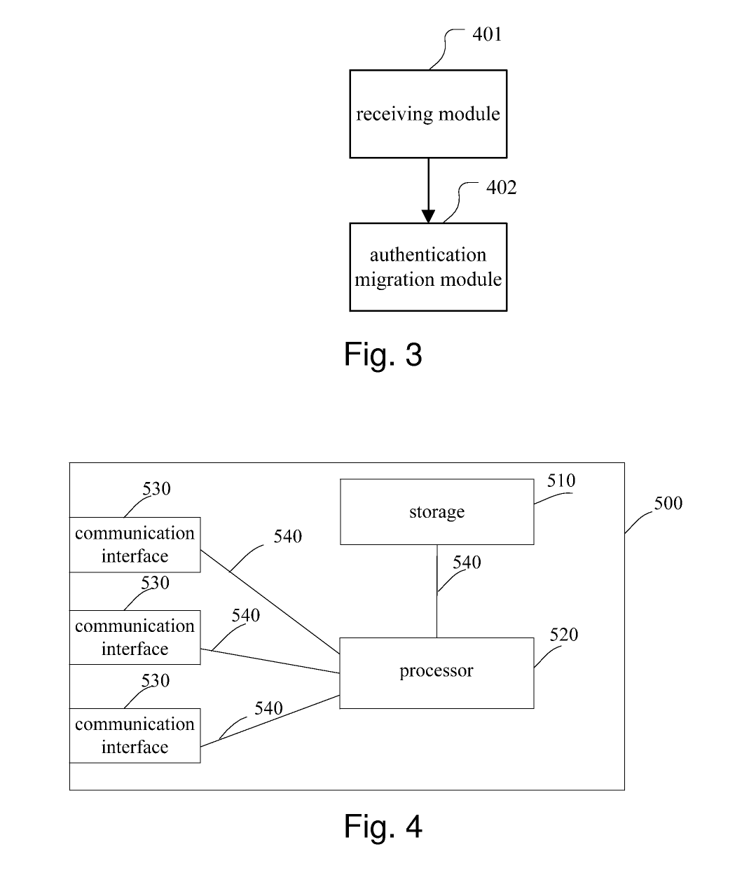

An example of the present disclosure also provides a device for implementing routing protocol authentication migration, which is described with reference to FIG. 3 hereinafter.

FIG. 3 is a diagram illustrating a device for implementing routing protocol authentication migration according to an example of the present disclosure. The device may be applied to a routing device, and may include a receiving module 401 and an authentication migration module 402.

The receiving module 401 may receive a first migration instruction, a second migration instruction and a protocol packet containing authentication information.

When the receiving module 401 receives the first migration instruction, the authentication migration module 402 configures new authentication information on the routing device according to the first migration instruction, configures the authentication direction of the new authentication information as a receiving direction to enable the routing device to receive a protocol packet containing the new authentication information. When the receiving module 401 receives the second migration instruction, the authentication migration module 402 configures the authentication direction of original active authentication information as the receiving direction and configures the authentication direction of the new authentication information as the receiving direction and a sending direction to enable the routing device to receive a protocol packet containing the original active authentication information, and receive and send protocol packet containing the new authentication information.

After the authentication migration module 402 enables the routing device to receive the protocol packet containing the new authentication information, the authentication migration may be terminated when the receiving module 401 receives protocol packets containing the new authentication information from all adjacent routing devices.

The authentication information may include an authentication mode and an authentication password.

In an example, the first migration instruction may contain the authentication information.

The authentication migration module 402 configures the authentication information contained in the first migration instruction on the routing device as the new authentication information when configuring the new authentication information on the routing device according to the first migration instruction.

In another example, the first migration instruction may contain an authentication information identity.

When configuring the new authentication information on the routing device according to the first migration instruction, the authentication migration module 402 searches a pre-stored authentication information list for authentication information corresponding to the authentication information identity contained in the first migration instruction, and configures the searched-out authentication information on the routing device as the new authentication information.

In an example, the authentication migration module 402 further starts a smooth migration timer when configuring the authentication direction of the new authentication information as the receiving direction and the sending direction.

If the smooth migration timer started by the authentication migration module 402 expires, the authentication migration may be terminated.

In an example, the original active authentication information may be deleted when terminating the authentication migration.

In an example, interface-based protocol authentication is adopted. RIP, BFD protocol, OSPF protocol and IS-IS protocol may support the interface-based protocol authentication. The all adjacent routing devices are adjacent routing devices of the routing device that are connected to the interface.

In another example, when TCP-based protocol authentication is adopted, BGP may support the TCP-based protocol authentication. The all adjacent routing devices are opposite adjacent routing devices associated with the routing device through a TCP connection.

In another example, when device-based protocol authentication is adopted, the RIP, the BFD protocol, the OSPF protocol, the IS-IS protocol and the BGP may support the device-based protocol authentication. The all adjacent routing devices are routing devices connected to the routing device.

In another example, when domain-based protocol authentication is adopted, the OSPF protocol and the IS-IS protocol may support the device-based protocol authentication. The all adjacent routing devices are routing devices located in the same domain as the routing device.

In actual applications, the method and the device for implementing routing protocol authentication migration may be implemented through hardware structure of routing device to which the method and the device are applied.

FIG. 4 is a diagram illustrating the hardware structure of a routing device to which the method and the device for implementing routing protocol authentication migration is applied according to an example of the present disclosure. As shown in FIG. 4, a routing device 500 to which the method and the device applied includes a storage 510, a processor 520, a communication interface 530 and a connection structure coupling with the storage 510, the processor 520 and the communication interface 530.

The storage 510 may store all authentication information of the routing device, which includes original active authentication information and new authentication information. The storage 510 further store computer readable instructions that may executed by the processor 520.

The processor 520 may be a CPU. Through executing the computer readable instructions stored in the storage 510, the processor 520 may implement the functions of a receiving module, an authentication migration module and an authentication terminating module. The receiving module receives a first migration instruction and a second migration instruction from a management device through the communication interface, and receives a protocol packet containing the new authentication information or the original active authentication information from an adjacent routing device through the communication interface. The authentication migration module configures or modifies authentication information on the routing device according to the first migration instruction and the second migration instruction received by the receiving module. The authentication terminating module determines whether to terminate the authentication migration according to whether the receiving module receives protocol packets containing the new authentication information from all adjacent routing devices.

The communication interface 530 forwards the first migration instruction and the second migration instruction sent by the management device and protocol packets containing the authentication information sent by adjacent routing devices to the receiving module.

The methods and modules in this disclosure may be implemented in hardware (e.g. ASIC, FPGA etc), software or firmware (e.g. machine readable instructions stored in non-transitory memory and executed by a processor) or a combination of both. Furthermore the method and each module may be performed by one processor or logic device or distributed over several processors or logic devices, depending upon the structure of the hardware.

In the example of the present disclosure, the authentication direction of the new authentication information is configured as the receiving direction in the first phase of authentication migration, the authentication direction of the new authentication information is configured as the receiving direction and the sending direction and the authentication direction of the original active authentication information is configured as the receiving direction in the second phase of authentication migration, and the authentication migration terminates in the third phase of authentication migration. Accordingly, the protocol packets containing the same authentication information may be sent during the authentication migration, thereby avoiding a case that a large number of protocol packets are sent, and further improving processing performance of device.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for implementing routing protocol authentication migration, applied to a routing device and comprising:
receiving a first migration instruction from a management device, configuring new authentication information on the routing device according to the first migration instruction, and configuring an authentication direction of the new authentication information as a receiving direction to enable the routing device to receive a protocol packet containing the new authentication information;
receiving a second migration instruction that is sent by the management device after determining that all adjacent routing devices have configured the new authentication information, configuring an authentication direction of original active authentication information as a receiving direction and configuring the authentication direction of the new authentication information as the receiving direction and a sending direction to enable the routing device to receive a protocol packet containing the original active authentication information, and receive and send a protocol packet containing the new authentication information;
wherein both the new authentication information and the original active authentication information include an authentication mode and an authentication password.

2. The method of claim 1, wherein the first migration instruction contains authentication information; and
the configuring the new authentication information on the routing device according to the first migration instruction comprises: configuring the authentication information contained in the first migration instruction on the routing device as the new authentication information.

3. The method of claim 1, wherein the first migration instruction contains an authentication information identity; and
the configuring the new authentication information on the routing device according to the first migration instruction comprises: searching a pre-stored authentication information list for authentication information corresponding to the authentication information identity contained in the first migration instruction, and configuring the searched-out authentication information on the routing device as the new authentication information.

4. The method of claim 1, after configuring the new authentication information on the routing device according to the first migration instruction, further comprising: returning a configuration succession confirming packet;
the determining that all adjacent routing devices have configured the new authentication information comprises one of:
when receiving configuration succession confirming packets from all adjacent routing devices, determining that all adjacent routing devices have configured the new authentication information; and
starting a timer when the management device sends the first migration instruction; when the timer expires, determining that all adjacent routing devices have configured the new authentication information.

5. The method of claim 1, when configuring the authentication direction of the new authentication information as the receiving direction and the sending direction, further comprising:
starting a smooth migration timer; and
terminating the authentication migration when the smooth migration timer expires.

6. The method of claim 1, after enabling the routing device to receive a protocol packet containing the new authentication information and receiving protocol packets containing the new authentication information from all adjacent routing devices, further comprising:
deleting the original active authentication information.

7. The method of claim 1, wherein
when interface-based protocol authentication is adopted, Routing Information Protocol (RIP), Bidirectional Forwarding Detection (BFD) protocol, Open Shortest Path First (OSPF) protocol and Intermediate System-to-Intermediate System (IS-IS) protocol all support the interface-based protocol authentication, and the all adjacent routing devices are adjacent routing devices of the routing device that are connected to the interface;
when TCP-based protocol authentication is adopted, Border Gateway Protocol (BGP) supports the TCP-based protocol authentication, and the all adjacent routing devices are opposite adjacent routing devices associated with the routing device through a TCP connection;
when device-based protocol authentication is adopted, the RIP, the BFD protocol, the OSPF protocol, the IS-IS protocol and the BGP all support the device-based protocol authentication, and the all adjacent routing devices are routing devices connected to the routing device; and
when domain-based protocol authentication is adopted, the OSPF protocol and the IS-IS protocol both support the device-based protocol authentication, and the all adjacent routing devices are routing devices located in the same domain as the routing device.

8. A device for implementing routing protocol authentication migration, applied to a routing device and comprising a receiving module and an authentication migration module;
the receiving module is to receive a first migration instruction, a second migration instruction and a protocol packet containing authentication information;
the authentication migration module is to, when the receiving module receives the first migration instruction, configure new authentication information on the routing device according to the first migration instruction, configures an authentication direction of the new authentication information as a receiving direction to enable the routing device to receive a protocol packet containing the new authentication information; when the receiving module receives the second migration instruction that is sent by a management device after determining that all adjacent routing devices have configured the new authentication information, to configure an authentication direction of original active authentication information as the receiving direction and configure the authentication direction of the new authentication information as the receiving direction and a sending direction to enable the routing device to receive a protocol packet containing the original active authentication information, and receive and send protocol packets containing the new authentication information;
wherein both the new authentication information and the original active authentication information include an authentication mode and an authentication password.

9. The device of claim 8, wherein the first migration instruction contains the authentication information; and
the authentication migration module is to configure the authentication information contained in the first migration instruction on the routing device as the new authentication information according to the first migration instruction.

10. The device of claim 8, wherein the first migration instruction contains an authentication information identity; and
the authentication migration module is to search a pre-stored authentication information list for authentication information corresponding to the authentication information identity contained in the first migration instruction, and configure the searched-out authentication information on the routing device as the new authentication information.

11. The device of claim 8, further comprising an authentication terminating module,
the authentication migration module is to start a smooth migration timer when configuring the authentication direction of the new authentication information as the receiving direction and the sending direction; and
the authentication terminating module is to terminate the authentication migration if the smooth migration timer started by the authentication migration module expires.

12. The device of claim 8, further comprising an authentication terminating module,
the authentication terminating module is to delete the original active authentication information after the authentication migration module enables the routing device to receive the protocol packet containing the new authentication information and the receiving module receives protocol packets containing the new authentication information from all adjacent routing devices.

13. The device of claim 8, wherein
when interface-based protocol authentication is adopted, Routing Information Protocol (RIP), Bidirectional Forwarding Detection (BFD) protocol, Open Shortest Path First (OSPF) protocol and Intermediate System-to-Intermediate System (IS-IS) protocol all support the interface-based protocol authentication, and the all adjacent routing devices are adjacent routing devices of the routing device that are connected to the interface;
when TCP-based protocol authentication is adopted, Border Gateway Protocol (BGP) supports the TCP-based protocol authentication, and the all adjacent routing devices are opposite adjacent routing devices associated with the routing device through a TCP connection;
when device-based protocol authentication is adopted, the RIP, the BFD protocol, the OSPF protocol, the IS-IS protocol and the BGP all support the device-based protocol authentication, and the all adjacent routing devices are routing devices connected to the routing device; and
when domain-based protocol authentication is adopted, the OSPF protocol and the IS-IS protocol both support the device-based protocol authentication, and the all adjacent routing devices are routing devices located in the same domain as the routing device.
